(19) United States
(12) Patent Application Publication
(10) Pub. No.: US 2017/0269295 A1
(43) Pub. Date: Sep. 21, 2017

(54) APPARATUS FOR COMPENSATING DISPLAYED IMAGE AND DISPLAY ASSEMBLY

(71) Applicant: HON HAI PRECISION INDUSTRY CO., LTD., New Taipei (TW)

(72) Inventor: I-WEI WU, New Taipei (TW)

(21) Appl. No.: 15/615,278

(22) Filed: Jun. 6, 2017

Related U.S. Application Data
(63) Continuation of application No. 14/494,059, filed on Sep. 23, 2014.

(30) Foreign Application Priority Data
Sep. 27, 2013 (TW) 102135211

(51) Int. Cl. G02B 6/08; G02F 1/1335; G02F 1/1333

(52) U.S. Cl. CPC G02B 6/08; G02F 1/13336; G09G 2300/026; G02F 1/133524

(57) ABSTRACT

An image compensating apparatus for portraying a seamless display in a display comprising multiple screens includes a light incident surface set on the display region, a light emitting surface parallel to the light incident surface, and a plurality of light guiding channels parallel to each other. The display panel includes display and non-display regions, the non-display region surrounding a periphery of the display region. The light guiding channels interconnect with the light incident surface and the light emitting surface, and form angles with the light incident surface. A projection of each of the light guiding channels on the light incident surface is parallel to a diagonal line of the light incident surface. Viewed perpendicular to the light incident surface, the light guiding channel transposes an image displayable on the display region along a first direction and a second direction for covering at least part of the non-display region.

### CROSS-REFERENCE TO RELATED APPLICATIONS

This application is a continuation application of U.S. patent application Ser. No. 14/447,986 filed on Jul. 31, 2014. This application is related to U.S. patent application Ser. No. 14/164,118 filed on Jan. 24, 2014, entitled “DISPLAY DEVICE, JOINT DISPLAY AND BACKLIGHT MODULE”; U.S. patent application Ser. No. 14/164,139 filed on Jan. 25, 2014, entitled “APPARATUS FOR COMPENSATING IMAGE OF DISPLAY AND METHOD FOR MANUFACTURING SAME”; U.S. patent application Ser. No. 14/164,140 filed on Jan. 25, 2014, entitled “APPARATUS FOR COMPENSATING IMAGE OF DISPLAY AND METHOD FOR MANUFACTURING SAME”; U.S. patent application Ser. No. 14/164,136 filed on Jan. 25, 2014, entitled “APPARATUS FOR COMPENSATING IMAGE OF DISPLAY, DISPLAY AND JOINT DISPLAY”; U.S. patent application Ser. No. 14/164,137 filed on Jan. 25, 2014, entitled “DISPLAY ELEMENT, DISPLAY DEVICE AND JOINT DISPLAY”; and U.S. patent application Ser. No. 14/494,059 filed on Sep. 27, 2014, entitled “APPARATUS FOR COMPENSATING IMAGE OF DISPLAY AND DISPLAY ASSEMBLY”. This application claims priority to U.S. patent application Ser. No. 14/447,986 filed on Jul. 31, 2014, the contents of which are incorporated by reference herein.

### FIELD

The present disclosure relates to an image compensating apparatus disposed upon a display panel.

### BACKGROUND

In order to obtain a display panel with a large dimension, a large number of displays serially jointed together in a plane can be put together. The borders between two adjacent display panels jointed together should be invisible.

### BRIEF DESCRIPTION OF THE FIGURES

Implementations of the present technology will now be described, by way of example only, with reference to the attached figures, wherein:

FIG. 1 is a partially exploded view of an exemplary embodiment of a display, the display including an image compensating apparatus.

FIG. 2 is an assembled isometric view of an exemplary embodiment of the display of FIG. 1.

FIG. 3 is a cross-sectional view of an exemplary embodiment of the display of FIG. 2 taken along a line thereof, the display including a light guiding fiber.

FIG. 4 is an isometric view of an exemplary embodiment of the light guiding fiber of FIG. 3.

FIG. 5 is an isometric view of an exemplary embodiment of the compensating apparatus of FIG. 1.

FIG. 6 is a partially exploded view of another exemplary embodiment of the display.

FIG. 7 is an assembled isometric view of an exemplary embodiment of the display of FIG. 6.

FIG. 8 is a cross-sectional view of an exemplary embodiment of the display of FIG. 7 taken along a line VIII-VIII thereof

FIG. 9 is a cross-sectional view of an exemplary embodiment of the display of FIG. 7 taken along a line IX-IX thereof

FIG. 10 is an isometric view of a first exemplary embodiment of a display assembly for two joined displays of FIG. 1.

FIG. 11 is a cross-sectional view of an exemplary embodiment of the display of FIG. 10 taken along a line XI-XI thereof

FIG. 12 is a cross-sectional view of a second exemplary embodiment of the display assembly for two joined displays of FIG. 1.

FIG. 13 is an isometric view of a third exemplary embodiment of a display assembly for two joined displays of FIG. 2.

FIG. 14 is a partially exploded view of a fourth exemplary embodiment of a display assembly.

FIG. 15 is a cross-sectional view of an exemplary embodiment of the display assembly of FIG. 14.

FIG. 16 is a cross-sectional view of a fifth exemplary embodiment of a display assembly.

FIG. 17 is an isometric view of a sixth exemplary embodiment of a display assembly.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

The present disclosure is described in relation to a display with a zero border effect.

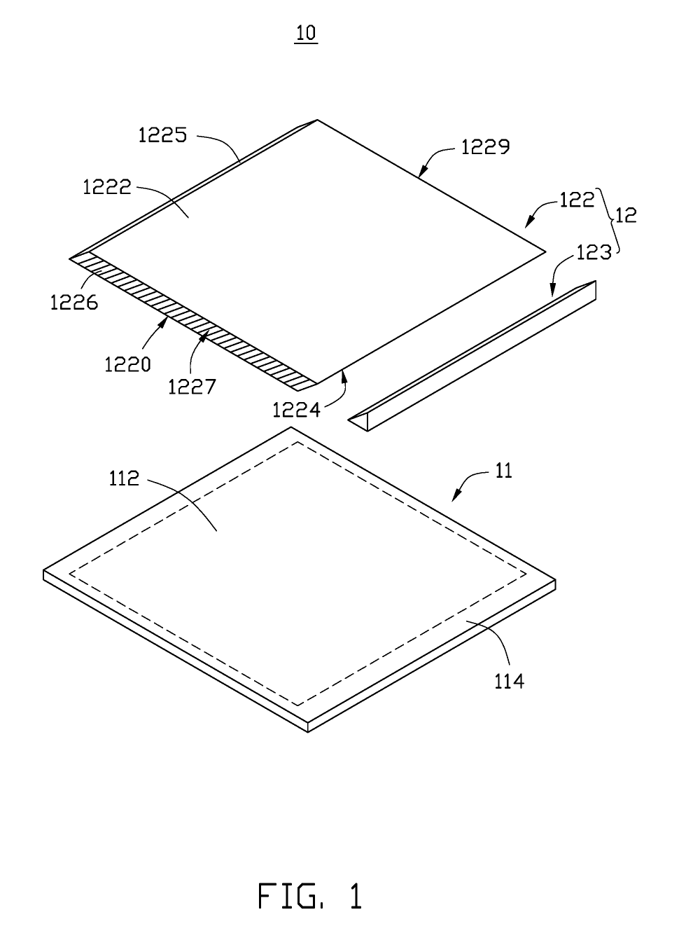

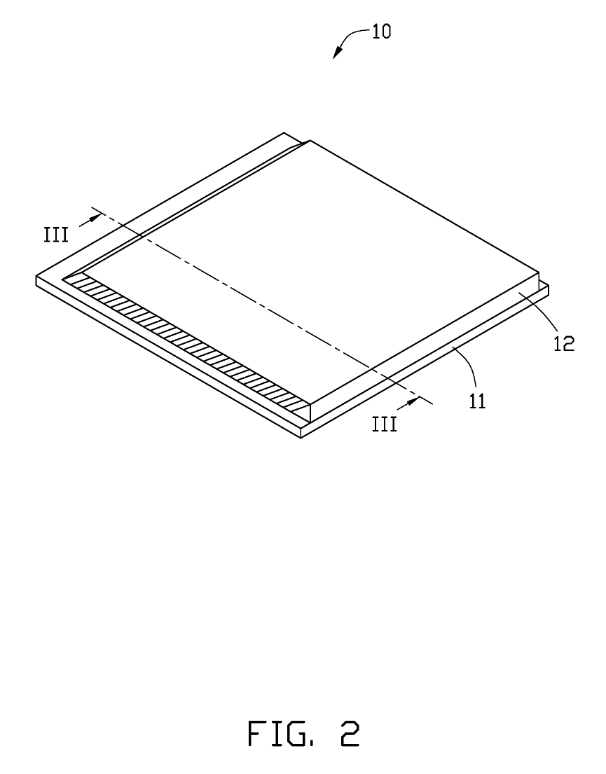

FIG. 1 illustrates an exemplary embodiment of a display 10. The display 10 includes a display panel 11 and an image compensating apparatus 12 located on the display panel 11 (as shown in FIG. 2). In at least one exemplary embodiment, the display panel 11 is a liquid crystal display (LCD) panel or an organic light emitting display (OLED) panel.

The display panel 11 includes a display region 112 and a non-display region 114 around a periphery of the display region 112. In at least one exemplary embodiment, the non-display region 114 is a frame of the display 10.

The image compensating apparatus 12 includes an image compensating portion 122 set on the display region 112 and a supporting portion 123 overlapped on the non-display region 114 when viewed along a direction perpendicular to the display panel 11. The image compensating portion 122 displays an image that could be displayed on the display region 112, and projects it on the non-display region 114 for covering at least a part of the non-display region 114.

The image compensating portion 122 includes a light incident surface 1220 abutting the display region 112, a light emitting surface 1222 parallel to the light incident surface 1220, and a plurality of light guiding channels 1226 parallel to each other. In at least one exemplary embodiment, the image compensating portion 122 is substantially a parallelepiped.

FIGS. 1 with 3 illustrates that the image compensating portion 122 further includes a first inclined surface 1224, a second inclined surface 1225 opposite to the first inclined surface 1224, a first connecting surface 1227, and a second connecting surface 1229 opposite to the first connecting surface 1227. The first inclined surface 1224, the first connecting surface 1227, the second inclined surface 1225, and the second connecting surface 1229 extend from the four edges of the light incident surface 1220, and are interconnecting with the light emitting surface 1222. The first inclined surface 1224 and the light incident surface 1220 may define an obtuse angle, which is within a range of 130 degrees to 150 degrees. The second inclined surface and the light incident surface 1220 may define an acute angle, which is within a range of 30 degrees to 50 degrees. The first connecting surface 1227 and the second connecting surface 1229 are perpendicular to the light incident surface 1220. In the at least one exemplary embodiment, the obtuse angle is 135 degrees.

Each of the light guiding channels 1226 extends from the light incident surface 1220 to the light emitting surface 1222 along the predetermined direction. Cross-section areas of each of the light guiding channels 1226 are constant, which means diameter of each of the light guiding channels 1226 is constant. Each light guiding channel 1226 and the light incident surface 1220 can define an acute angle, which is within a range of 30 degrees to 50 degrees. In at least one exemplary embodiment, the predetermined direction is parallel to the first inclined surface 1224, the second inclined surface 1225, the first connecting surface 1227, and the second connecting surface 1229.

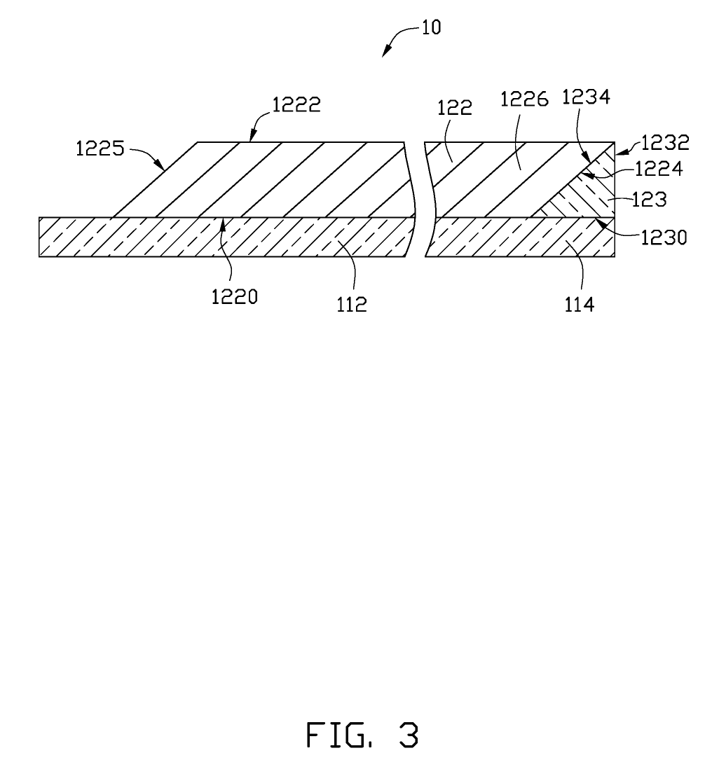

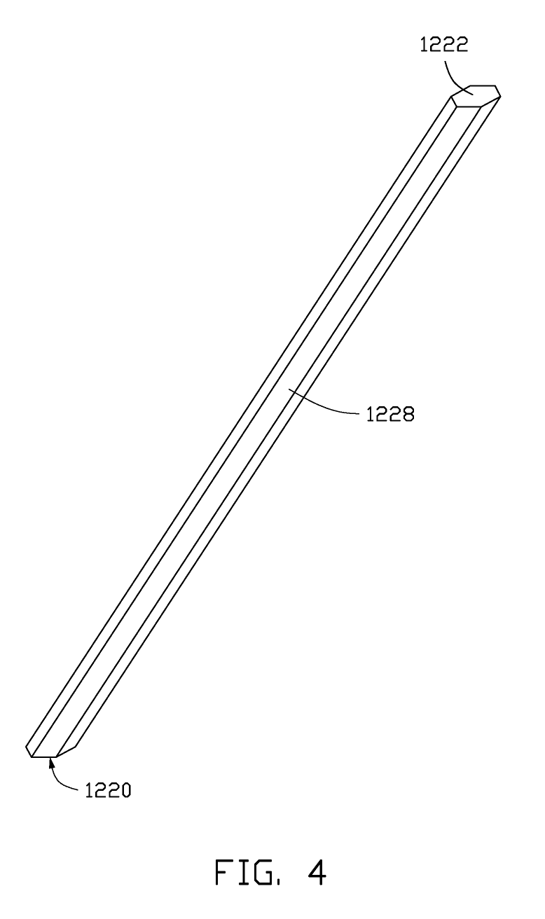

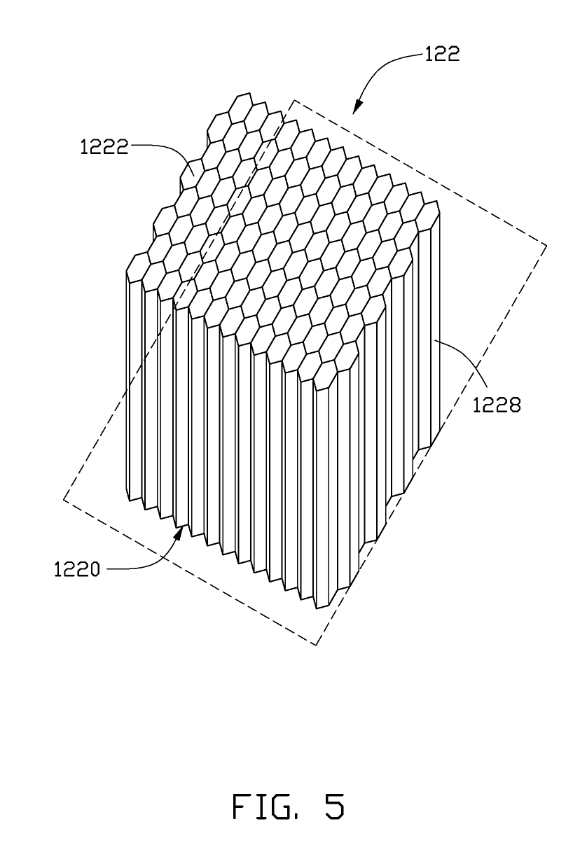

FIGS. 4 and 5 illustrate that the light guiding light channels 1226 are defined by a plurality of light guiding fibers 1228. The light guiding fibers 1228 are arranged in a parallelepiped bunch. Each of the light guiding fibers 1228 is extended from the light incident surface 1220 to the light emitting surface 1222. Cross-section area of the light guiding fiber 1228 is constant (for example, diameters of the light guiding fibers 1228 from the light incident surface 1220 to the light emitting surface 1222 are constant). Referring to FIG. 3, a projection of each of the light guiding channel 1226 on the light incident surface 1220 overlaps with an edge of the light incident surface 1220. Based on the arrangement, the light guiding channel 1226 transposes the image displayed on the display panel 11 along a direction parallel to the edge of the light incident surface 1220, which overlaps with the projection of the light guiding channel 1226. In other exemplary embodiments, the light guiding channels 1226 can be combined with a number of optical fibers, light guiding thin plates, silica fibers, glass fibers, or other light transmitting material.

The supporting portion 123 includes a bottom surface 1230 abutting the non-display region 114, a first wall 1232 perpendicular to the bottom surface 1230, and a second wall 1234 interconnecting the bottom surface 1230 and the first wall 1232. The second wall 1234 is coplanar to the first inclined surface 1224. Cross-section area of the supporting portion 123 is a right triangle. In at least one exemplary embodiment, the supporting portion 123 is made of transparent material. The second wall 1234 is bonded with the first inclined surface 1224 by a colloid. In other exemplary embodiments, the supporting portion 123 is made of opaque metals or plastic materials.

Referring to FIG. 3, light from the light incident surface 1220 provided by an image displayed on the display region 112 is guided to the light emitting surface 1222 by the light guiding channel 1226. When viewed from a direction perpendicular to the display panel 11, the inclined light guiding channels 1226 transpose an optical path of light from the light incident surface 1220 to the light emitting surface 1222 in a predetermined distance along a direction parallel to the edge of the incident surface 1220. In other words, the inclined light guiding channels 1226 transpose an image at the light guiding channels 1226 from the light emitting surface 1222 to the projection of the compensation portion in the predetermined distance along a direction parallel to the edge of the incident surface 1220 for overlapping the non-display region 114. The image outputted by the light emitting surface 1222 covers at least part of the non-display region 114. The image displayed by the display panel 11 is an image displayed on the display region 112, or an image provided to the light incident surface 1220. In at least one exemplary embodiment, light guiding channels 1226 transpose the image from the light emitting surface 1222 to the non-display region 114 in the predetermined distance towards the right direction of the display region 112. The predetermined distance is equal to a length of a projection of the light guiding channel 1226 onto the light incident surface 1220, and the predetermined distance is greater than or equal to a width of the non-display region 114 for completely covering the partial non-display region 114 located at one side of the display region 112 (for example, an area located on a right side of the display region 112). Based on the constant cross section of the light guiding channel 1226, all of the light guiding channel 1226 transpose the image from the light incident surface 1220 to the light emitting surface 1222 in the predetermined distance, so preventing the image from being distorted, thus the display quality of the display 10 is stable. In other exemplary embodiments, the image outputted by the light emitting surface 1222 covers part of the non-display region 114, which is located at upper side of the display region 112. Thus, the non-display region 114 is partly invisible to a viewer and the display 10 has a no border effect.

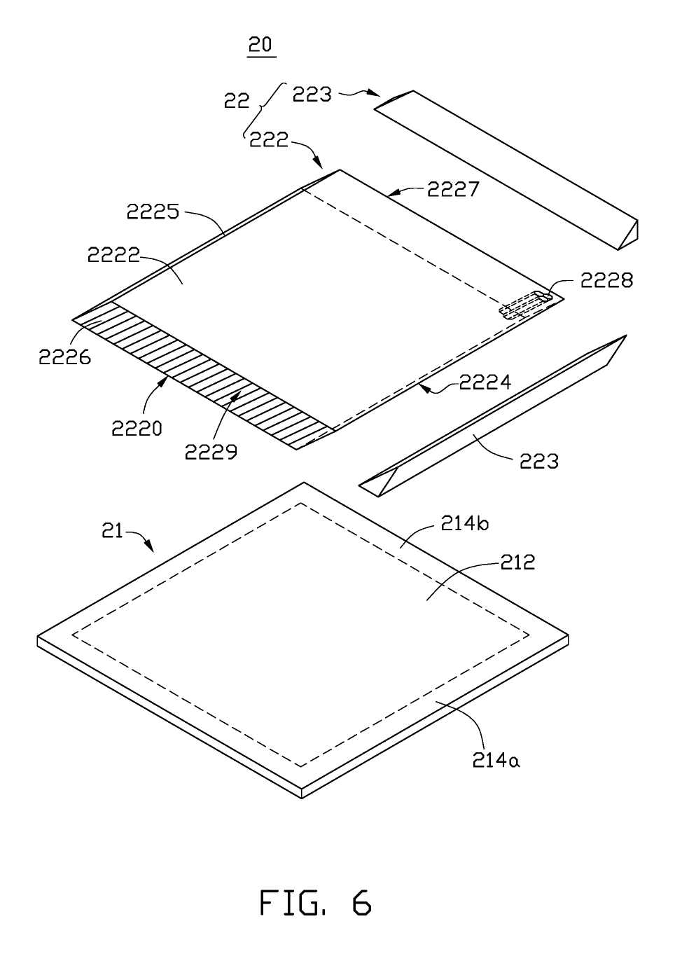

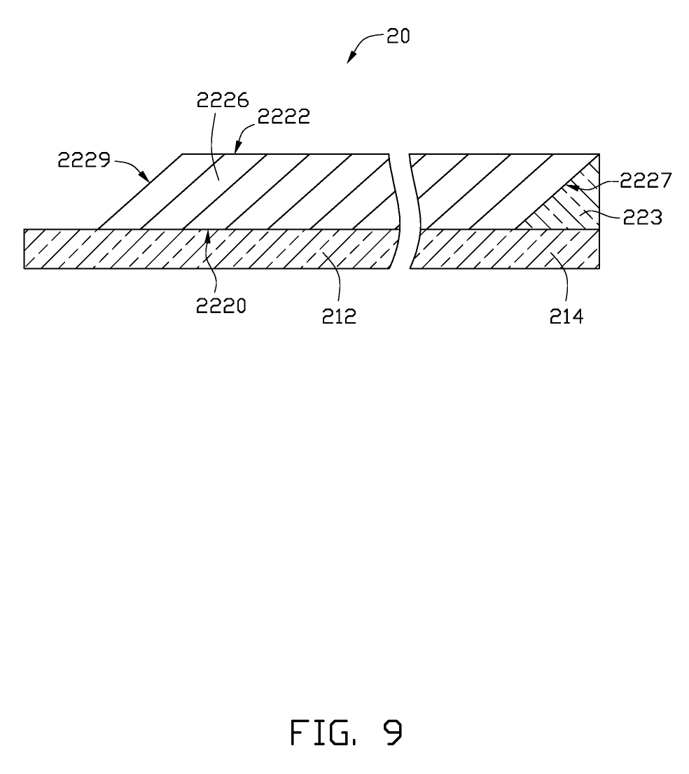

FIGS. 6-9 illustrate another exemplary embodiment of the display 20. The image compensating apparatus 22 includes an image compensating portion 222, two supporting portions 223, and a plurality of light guiding channels 2226. The image compensating portion 222 is substantially a hexahedron in shape. The image compensating portion 222 includes a light incident surface 2220, a light emitting surface 2222 parallel to the light incident surface 2220, a first inclined surface 2224, a second inclined surface 2225 parallel to the first inclined surface 2224, a third inclined surface 2227, and a fourth inclined surface 2229 parallel to the third inclined surface 2227. The first inclined surface 2224, the third inclined surface 2227, the second inclined surface 2225, and the fourth inclined surface 2229 are extended from four edges of the incident surface 2220, and are interconnected with the light emitting surface 2222. The incident surface 2220 is substantially a parallelogram. The third inclined surface 2227 and the fourth inclined surface 2229 are position at an angle with the light incident surface 2220. The third inclined surface 2227 and the light incident surface 2220 may define an obtuse angle, which is within a range of 130 degrees to 150 degrees. The fourth inclined surface 2229 and the light incident surface 2220 may define an acute angle, which is within a range of 30 degrees to 50 degrees.

The supporting portions 223 correspond in shape to the first inclined surface 2224 and the third inclined surface 2227. The structure of the supporting portion 223 is same as that of the supporting portion 123 in the previous exemplary embodiment, and overlaps with the non-display region 214 viewed along a direction perpendicular to the display panel 1. The extended direction of the light guiding channel 2226 is parallel to the first inclined surface 2224, the third inclined surface 2227, the second inclined surface 2225, and the fourth inclined surface 2229, and is different from the extended direction of the light guiding channel 1226. A projection of each of the light guiding channels 2226 on the light incident surface 2220 is substantially parallel to a diagonal line of the light incident surface 2220. A projection of the light guiding channel 226 has a first component extending along a direction parallel to a lengthwise edge of the light incident surface 2220 and a second component extending along a direction parallel to a wide edge of the light incident surface 2220. Based on this arrangement, the light guiding channel 2226 transposes the image displayed on the display panel 21 along two directions.

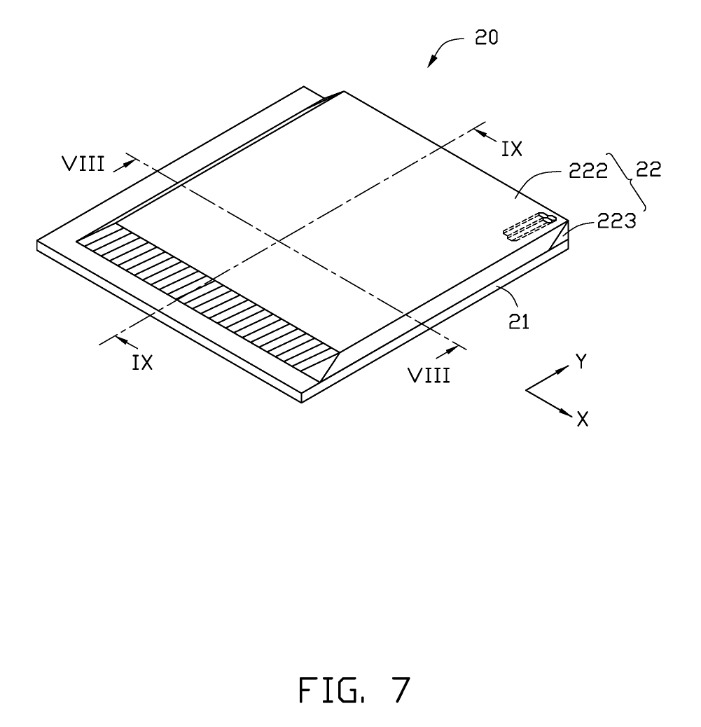

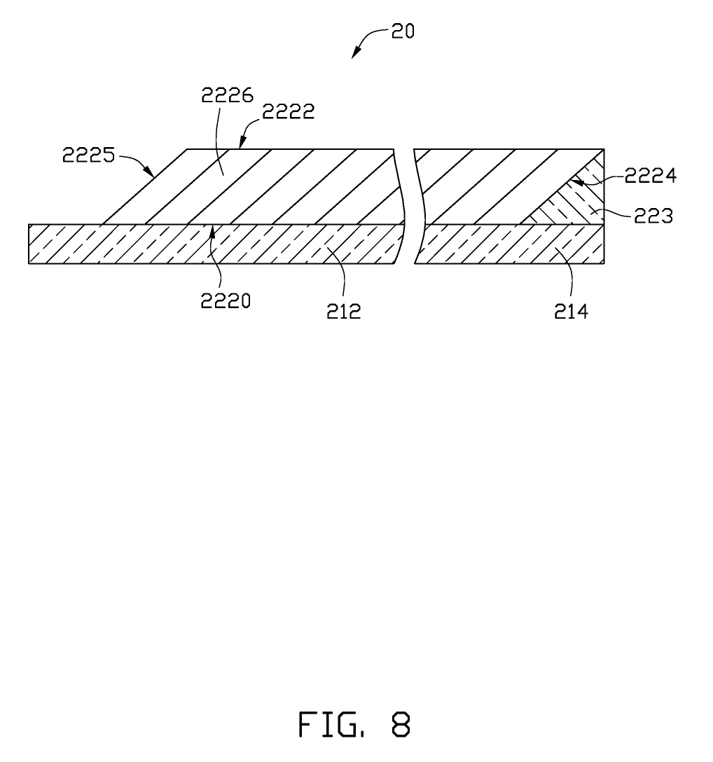

Referring to FIG. 7, when viewed from a direction perpendicular to the display panel 21, the light guiding channel 2226 transposes an optical path of light outputted by the display panel 21 in a first predetermined distance along a first direction X parallel to the long edge of the light incident surface 2220, and transposes an optical path of light outputted by the display panel 21 in a second predetermined distance along a second direction Y parallel to the wide edge of the light incident surface 2220 at the same time. Referring to FIG. 8, the image displayed by the display panel 21 is an image displayed on the display region 212 or is an image provided to the light emitting surface 2222. The image outputted by the light emitting surface 2222 covers part of the non-display region 214 which is located at a right side and the upper side of the display region 212. In at least one exemplary embodiment, the first predetermined distance is greater than or equal to a width of the non-display region 214a, which is located at the right side of the display region 212. The second predetermined distance is greater than or equal to a width of the non-display region 214b, which is located at the upper side of the display region 212. The non-display region 214 located at the right side and the upper side area of the display region 212 is completely covered by the image outputted by the light emitting surface 2222. The image outputted by the light emitting surface 2222 is parallel to the image displayed by the display panel 11. Thus, the non-display region 114 is partly invisible to a viewer and the display 10 has a zero border effect.

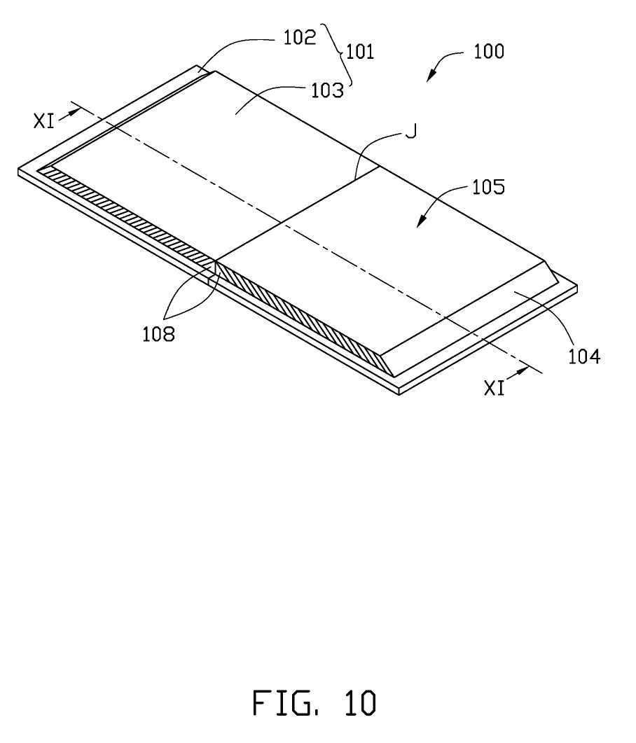

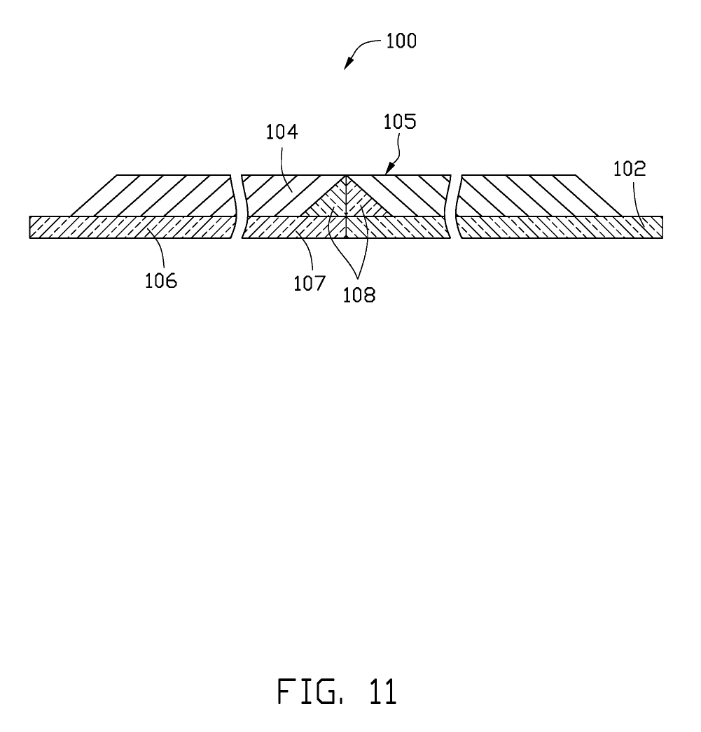

FIGS. 10 and 11 illustrate a display assembly 100 with two displays 101 parallel to each other. Each display 101 includes a display panel 102, an image compensating portion 103, and a supporting portion 108. The structure of the display 101 is the same as the structure of the display 10. A plurality of non-display regions 107 forms a joint J where the non-display regions 107 are connected. In assembly, the light emitting surfaces 105 of the displays 101 are interconnected to combine images outputted by the light emitting surfaces 105 as a uniform image. A projection of the image compensating portion 103 on the display panel 102 covers over the joint for maintaining a uniform image outputted by the image compensating portion 103 so as to completely cover the joint. Thus, the non-display region 107 is invisible to a viewer and the display apparatus 100 has a zero border effect.

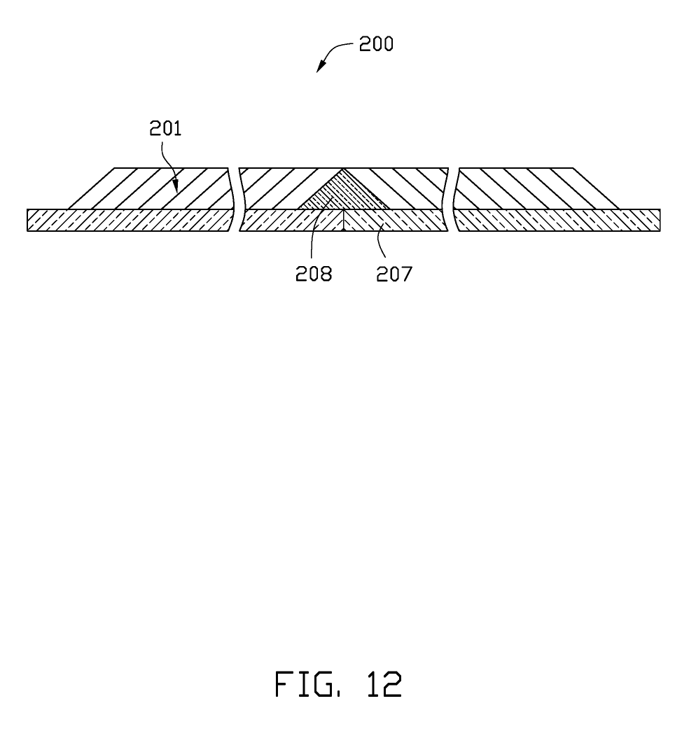

FIG. 12 illustrates the display assembly 200 with two displays 201. The supporting portions 208 of the display 201 are integrated and located over a joint of the non-display regions 207 of the displays 201.

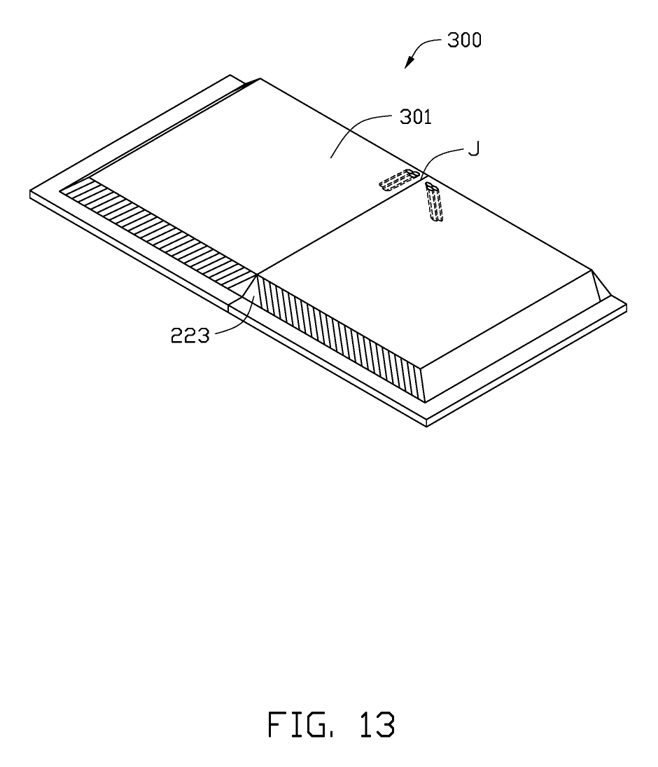

FIG. 13 illustrates the display assembly 300 with two displays 301. The supporting portions 223 of the displays 301 parallel to each other are jointed together. The structure of the display 301 is the same as the structure of the display 20.

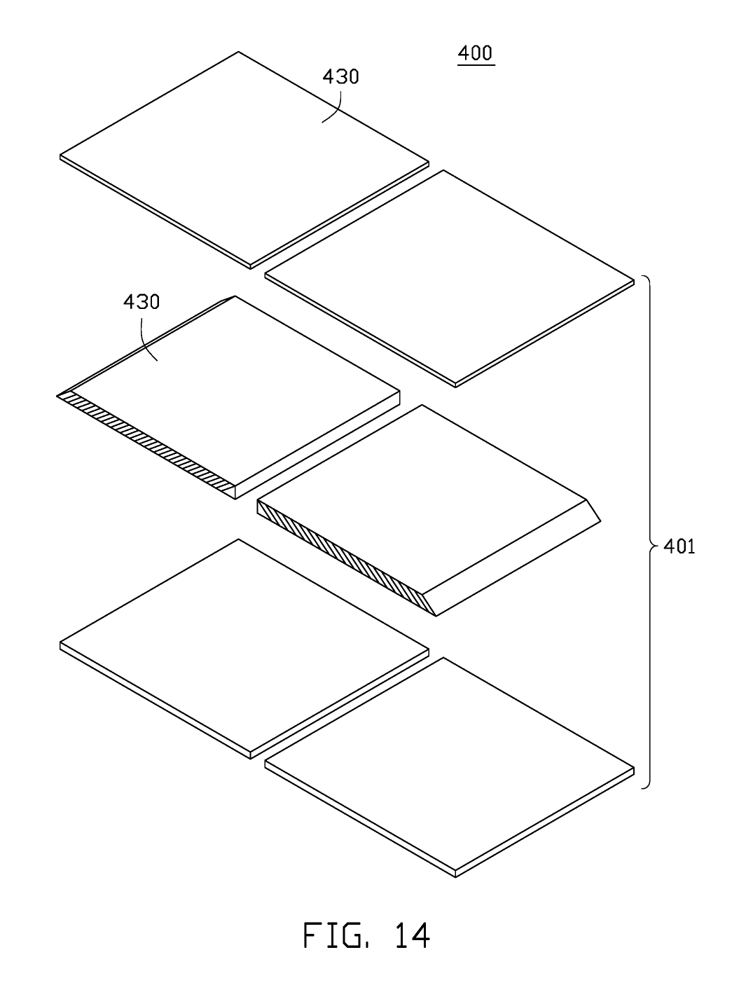

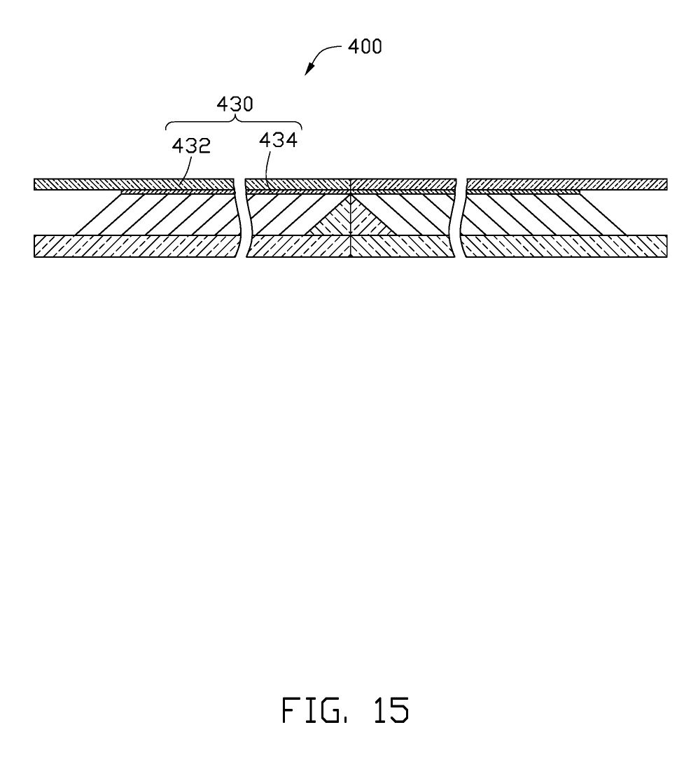

FIGS. 14 and 15 illustrate the display assembly 400 with two displays 401 and two image compensating apparatuses 403. The display 401 further includes a cover 430 overlapped the image compensating apparatus 403. The two covers 430 are jointed together. The cover 430 includes a base 432 and a touch sensing structure 434 between the base 432 and the display 401. The touch sensing structure 434 senses touches applied to the cover 430. In other exemplary embodiments, the two covers 430 are integrated.

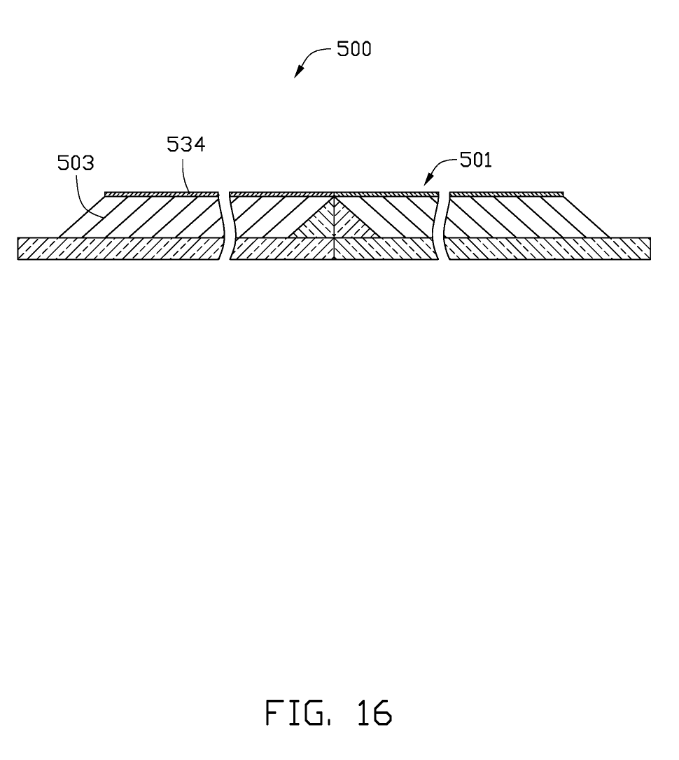

FIG. 16 illustrates the display assembly 500 with a display 501, which is similar to the display 101. The display 501 further includes a touch sensing structure 534 formed on a surface of the image compensating portion 503. The touch sensing structure 534 senses touches on the display assembly 500.

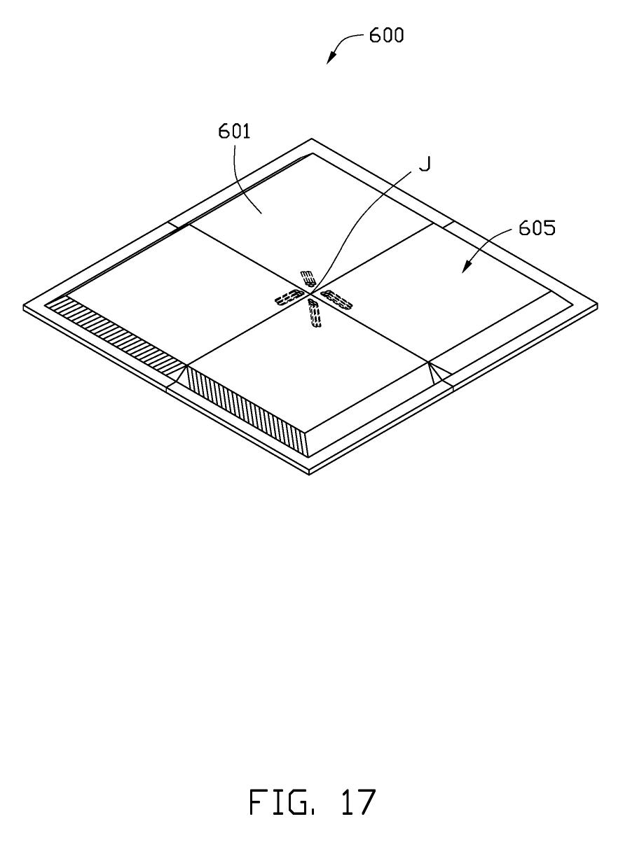

FIG. 17 illustrates the display assembly 600 with four displays 601 jointed together. The structure of the display 601 is same as that of the display 20. Light emitting surface 605 of each of the image compensating portion (shown but not labeled) are jointed together for combining all images outputted by the light emitting surfaces 605 together.

In use, the image compensating apparatus 12 transposes an image displayed on the display 10 so as to effectively cover the non-display region 114, thus frames of the display 10 is invisible and the effect of the display 10 is improved.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims.

What is claimed is:

1. An image compensating apparatus on a display panel, the display panel having a display region and a non-display region surrounding a periphery of the display region, the image compensating apparatus comprising:
an image compensating portion comprising a light incident surface contacting with the display panel, a light emitting surface parallel to the light incident surface, and a plurality of light guiding channels parallel to each other; and
a support portion;
wherein the light guiding channels are interconnected with the light incident surface; the light emitting surface is extended from the light incident surface to the light emitting surface; the incident surface is substantially a parallelogram; each of the light guiding channels forms an angle with the light incident surface; a projection of each of the light guiding channels on the light incident surface is parallel to a diagonal line of the light incident surface; an extended direction of the light guiding channel is parallel to a first inclined surface of the compensating portion, the compensating portion contacts with the supporting portion; the light guiding channels transpose an image displayed on the display region from the light incident surface to the light emitting surface in a first predetermined distance along a first direction, and transpose an image displayed on the display region from the light incident surface to the light emitting surface in a second predetermined distance along a second direction; the first direction and the second direction are parallel with two adjacent edges of the display.

2. The image compensating apparatus of claim 1, wherein a cross-section of each of the light guiding channels along an extending direction of the light guiding channels is constant.

3. The image compensating apparatus of claim 1, wherein the angle defined by the light guiding channel and the light incident surface is an acute angle within a range from 30 degrees to 50 degrees.

4. The image compensating apparatus of claim 1, wherein the projection of each of the light guiding channels has a first component along a direction parallel to a length edge of the light incident surface and a second component along a direction parallel to a width edge of the light incident surface.

5. The image compensating apparatus of claim 5, wherein the image displayed by the display panel transposes a first predetermined distance along a first direction parallel to the length edge of the light incident surface and a second predetermined distance along a second direction parallel to the width edge of the light incident surface.

6. The image compensating apparatus of claim 1, wherein the image compensating portion further comprises a second inclined surface parallel to the first inclined surface; the first inclined surface and the light incident surface defines an obtuse angle within a range from 130 degrees to 150 degrees; the second inclined surface and the light incident surface define an acute angle within a range from 30 degrees to 50 degrees; the light guiding channel are parallel to the first inclined surface and the second inclined surface.

7. The image compensating apparatus of claim 6, wherein the image compensating portion further comprises a first connecting surface and a second connecting surface parallel to the first connecting surface; the first connecting surface and the second connecting surface are perpendicular to the light incident surface; the first inclined surface, the first connecting surface, the second inclined surface, and the second connecting surface extend from edges of the light incident surface, and interconnect with the light emitting surface.

8. The image compensating apparatus of claim 6, wherein the image compensating portion further comprises a third inclined surface and a fourth inclined surface parallel to the first connecting surface; the third inclined surface and the light incident surface defines an obtuse angle within a range from 130 degrees to 150 degrees; the fourth inclined surface and the light incident surface define an acute angle within a range from 30 degrees to 50 degrees; the light guiding channels are parallel to the third inclined surface and the fourth inclined surface; the first inclined surface, the third inclined surface, the second inclined surface, and the fourth inclined surface extend from opposite edges of the light incident surface, and interconnect with the light emitting surface.

9. A display assembly comprising:
at least two displays arranged in parallel;
wherein each of the displays comprises a display panel with a display region and a non-display region connecting a periphery of the display region; at least one of the displays comprises an image compensating apparatus; the image compensating apparatus comprises a light incident surface contacted with the corresponding display panel, a light emitting surface parallel to the light incident surface, and a plurality of light guiding channels parallel to each other; the light guiding channels are interconnected with the light incident surface, the light emitting surface is extended from the light incident surface to the light emitting surface, each of the light guiding channels angles with the light incident surface; the incident surface is substantially in a parallelogram shape; a projection of each of the light guiding channels on the light incident surface is parallel to a diagonal line of the light incident surface; an extended direction of the light guiding channel is parallel to a first inclined surface of the compensating portion, the compensating portion contacts with the supporting portion; the light guiding channels transpose an image displayed on the display region from the light incident surface to the light emitting surface in a first predetermined distance along a first direction parallel with a length edge of the display, and transpose an image displayed on the display region from the light incident surface to the light emitting surface in a second predetermined distance along a second direction parallel with a wide edge of the display; first direction and the second direction are parallel with two adjacent edges of the display.

10. The display assembly of claim 9, wherein the display assembly comprises four displays jointed together, each of the display comprises an image compensating apparatus; each of the display further comprises a supporting portion set on the corresponding non-display region; the supporting portions are integrative configuration; the light emitting surface of each of the image compensating apparatus are jointed together for combining all images outputted by the light emitting surfaces together.

11. The display assembly of claim 9, wherein each of the displays comprises an image compensating apparatus; the light emitting surfaces of the displays are interconnected for combining images outputted by the corresponding light emitting surface together.

12. The display assembly of claim 9, wherein each of the displays comprises an image compensating apparatus; the light emitting surfaces of the displays interconnect for combining images outputted by the corresponding light emitting surface together.

13. The display assembly of claim 9, wherein a joint is formed where the non-display regions are connected; a projection of each of the image compensating portion on the corresponding display region is covered on the joint for keeping an image outputted by the image compensating portion completely covers the joint.

14. The display assembly of claim 9, wherein the supporting portion is overlapped with the corresponding display panel along a direction perpendicular to the display panel.

15. The display assembly of claim 9, wherein a cross section of each of the light guiding channels along an extending direction of the light guiding channels is constant, and the angle defined by the light guiding channel and the light incident surface is an acute angle within a range from 30 degrees to 50 degrees.

16. The display assembly of claim 9, wherein each of the displays further comprises a cover; the cover located on the corresponding image compensating apparatus; the cover comprises a base and a touch sensing structure located on the base; the touch sensing structure senses touch operations on the cover.

17. The display assembly of claim 9, wherein each of the displays further comprise a touch sensing structure located on the image compensating apparatus; the touch sensing structure senses touch operations on the display assembly.

18. The display assembly of claim 9, wherein the image compensating portion further comprises a first inclined surface and a second inclined surface parallel to the first inclined surface; the first inclined surface and the light incident surface defines an obtuse angle within a range from 130 degrees to 150 degrees; the second inclined surface and the light incident surface define an acute angle within a range from 30 degrees to 50 degrees; the light guiding channel are parallel to the first inclined surface and the second inclined surface.

19. The display assembly of claim 18, wherein the image compensating portion further comprises a first connecting surface and a second connecting surface parallel to the first connecting surface; the first connecting surface and the second connecting surface are perpendicular to the light incident surface; the first inclined surface, the first connecting surface, the second inclined surface, and the second connecting surface extend from edges of the light incident surface, and interconnect with the light emitting surface.

20. The display assembly of claim 18, wherein the image compensating portion further comprises a third inclined surface and a fourth inclined surface parallel to the first connecting surface; the third inclined surface and the light incident surface defines an obtuse angle within a range from 130 degrees to 150 degrees; the fourth inclined surface and the light incident surface define an acute angle within a range from 30 degrees to 50 degrees; the light guiding channel are parallel to the third inclined surface and the fourth inclined surface; the first inclined surface, the third inclined surface, the second inclined surface, and the fourth inclined surface extend from opposite edges of the light incident surface, and interconnect with the light emitting surface.
